(19) United States
(12) Patent Application Publication
(10) Pub. No.: US 2018/0330353 A1
(43) Pub. Date: Nov. 15, 2018

(54) Systems and Methods for Assessing Fees in Connection With Payment Account Transactions

(71) Applicant: MASTERCARD INTERNATIONAL INCORPORATED, Purchase, NY (US)

(72) Inventors: Anushree Ashutosh Prabhune, Stamford (GB); Christophe Mennes, Leuven (BE); Katrien Destoop, Overijse (BE); Gilberto Veri, Hyon (BE); Ilias Tranganidas, Forest (BE); Tine Fincioen, Tervuren (BE); Dmitriy Morgunov, Brussels (BE)

(21) Appl. No.: 15/637,314

(22) Filed: Jun. 29, 2017

(30) Foreign Application Priority Data
May 11, 2017 (GR) 20170100221

(51) Int. Cl. G06Q 20/22; G06Q 20/10; G06Q 40/02; G06Q 20/20; G06Q 20/32; G06Q 20/40

(52) U.S. Cl. CPC G06Q 20/227; G06Q 20/102; G06Q 20/40; G06Q 20/207; G06Q 20/322; G06Q 40/02

(57) ABSTRACT

Systems and methods are provided for use in assessing fees associated with payment account transactions. One exemplary method includes identifying, by at least one computing device, a transaction associated with a payment account where the payment account is associated with a consumer and issued by an issuer, and retrieving a fee schedule for the issuer where the fee schedule includes multiple fees and where each of the multiple fees is associated with the issuer and identified to at least one transaction dimension. The method also includes selecting, by the at least one computing device, at least one fee for the transaction from the multiple fees in the fee schedule based on at least one transaction dimension of the identified transaction, and providing the selected at least one fee for the identified transaction, whereby the at least one fee is assessed to the payment account for payment by the consumer.

### CROSS-REFERENCE TO RELATED APPLICATION

This application claims the benefit of and priority to Greek Patent Application No. 20170100221, filed May 11, 2017. The entire disclosure of the above application is incorporated herein by reference.

### FIELD

The present disclosure generally relates to systems and methods for use in facilitating payment account transactions and, in particular, to systems and methods for assessing fees in connection with payment account transactions based on particular issuers associated therewith.

### BACKGROUND

This section provides background information related to the present disclosure which is not necessarily prior art.

Payment account transactions are employed ubiquitously in commerce, whereby consumers purchase products (e.g., goods and/or services), through use of payment accounts. From time to time, payment account transactions involve merchants in one region, and issuers in another region, whereby the transactions are cross-border transactions. The issuers, in processing such transactions, are known to apply cross-border fees to the transactions, which are generally borne by the consumers associated with the payment accounts involved in the transactions. In addition, some cross-border transactions may further involve exchanges of currency (e.g., where the purchases involve merchants in the United States or Australia (and the currency involves dollars), and the issuers are present in Europe (which use Euros), etc.). In such transactions, currency exchange fees may also be applied to the transactions (e.g., as part of the cross-border fees, etc.), which are, again, borne by the consumers involved in the transactions.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use assessing fees in connection with payment account transactions based on particular issuers associated with payment accounts involved in the transactions;

FIG. 2 is a block diagram of a computing device that may be used in the exemplary system of FIG. 1; and

FIG. 3 is an exemplary method that may be implemented in connection with the system of FIG. 1 for assessing fees in connection with a payment account transaction.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Payment account transactions, from time to time, involve transactions in which merchants are located in one region, while issuers of the associated payment accounts are located in different regions. Fees are often imposed in such cross-border transactions, where the fees are indiscriminate, per issuer, regardless of the type of payment accounts involved, of the types of the corresponding transactions, etc. Uniquely, the systems and methods herein permit the issuers involved in the cross-border transactions, and other associated entities, to tune the fees associated therewith based on dimensions associated with the transactions and/or payment accounts to which the transactions are directed. In particular, for example, an assessment engine identifies a certain transaction, and retrieves a fee schedule for the issuer to which the transaction is directed. The assessment engine selects one or more fees for the transaction based on the fee schedule (e.g., cross-board fees, currency exchange fees, etc.), as identified to the transaction based on one or more dimensions therein. The assessment engine then notifies the issuer of the one or more fees and/or imposes the one or more fees to the transaction, whereby the one or more fees are assessed to the payment account involved in the transaction for payment by the consumer, for example, during the authorization process, the clearing process, or otherwise, etc. In this manner, the particular issuer involved in the cross-border transaction is able to set, specify, and/or tune the certain fees, for example, to account for different risks and/or aspects of the transaction, etc., potentially with the fees being applied (automatically) apart from the particular issuer (e.g., by a payment network including the assessment engine, etc.).

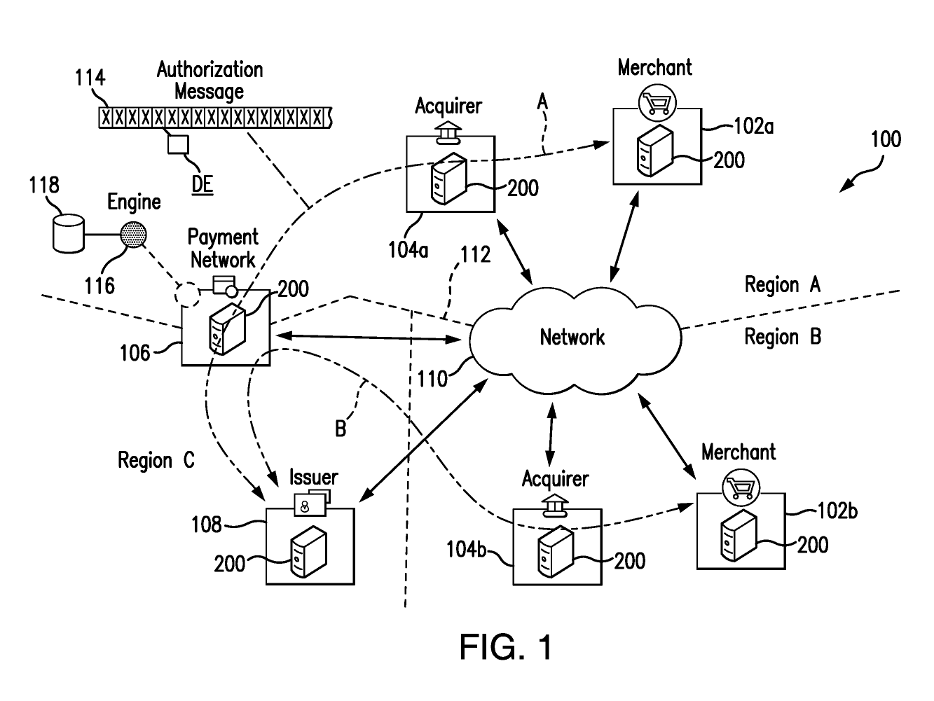

FIG. 1 illustrates an exemplary system 100, in which one or more aspects of the present disclosure may be implemented. Although the system 100 is presented in one arrangement, other embodiments may include the parts of the system 100 (or other parts) arranged otherwise depending on, for example, alternative regional groupings in the system 100 (for defining cross-border transactions, etc.), differing transactional roles between parts of the system 100, additional parties to transactions in the system 100, etc.

The system 100 generally includes two merchants 102a-b, two acquirers 104a-b generally associated with the merchants 102a-b, respectively, a payment network 106, and an issuer 108 configured to issue payment accounts to consumers, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, network 110 may include multiple different networks, such as a private payment transaction network made accessible by the payment network 106 to the acquirers 104a-b and the issuer and, separately, the public Internet, which may provide interconnection between the merchants 102a-b and the acquirers 104a-b (as appropriate), etc.

The illustrated system 100 also includes a border line 112 generally defining (or generally delineating between) three regions: Region A, Region B, and Region C. Specifically, the merchant 102a and the acquirer 104a are disposed or located in Region A; while the merchant 102b and the acquirer 104b are disposed in Region B and the issuer 108 is in Region C. The payment network 106 and network 110, in this embodiment, are included and/or available in Regions A, B and C despite the position of the same relative to the border lines in FIG. 1 (i.e., even if not expressly illustrated as such) to operate therein and/or enable communication, for example, by and/or between the parts of the system 100. With that said, it should be appreciated that the system 100 is not illustrated in FIG. 1 to indicate the actual physical arrangement of the parts of the system 100, but instead provides a general location of certain parts within the specified regions, thereby indicative of relative positions (e.g., the issuer 108 to the merchant 102a, etc.) and/or defining cross-border transactions (e.g., a transaction from Region A to Region B, etc.), for example.

In the illustrated embodiment, the border line 112 generally includes a country border, where Region A is a first country (e.g., a Single Euro Payments Area (SEPA) country, etc.), Region B is a second country (e.g., a non SEPA country, etc.), and Region C is a third country (e.g., a SEPA country, etc.). It should be appreciated, however, that in other embodiments, the border line 112 may delineate various different types of regions (e.g., territories, states, providences, cites, counties, etc.). Further, in this exemplary embodiment, the border line 112 delineates use of different currencies, for example, where a first currency is used in Region A (e.g., Euros, etc.) and a second currency is used in Regions B and C (e.g., US dollars, etc.). However, as with the country delineation, it should be appreciated that there is no requirement that the border line 112 represent a delineation of currencies (e.g., in this embodiment, for example, Region B and C utilize the same currencies, etc.).

Generally, in the system 100, from time to time, a consumer (not shown) performs a purchase transaction for one or more products (e.g., goods, services, etc.) with one of the merchants 102a-b, for example, using a payment account associated with the consumer and issued by the issuer 108. In connection therewith, the merchants 102a-b, the acquirers 104a-b (as associated with the merchants 102a-b), the payment network 106, and the issuer 108 cooperate, in response to the purchase transaction by the consumer, to complete a payment account transaction for purchase of the one or more products using the consumer's payment account.

In particular, for example, the consumer may desire to purchase a product for 100 Euros from the merchant 102a (referred to herein as Transaction A). To initiate the purchase transaction, the consumer initially presents a payment device associated with his/her payment account to the merchant 102a (e.g., as a card present transaction, etc.), where the payment account is issued to the consumer by the issuer 108. Since the merchant 102a is located in Region A and the issuer 108 is located in Region B, Transaction A involves a cross-border transaction. What's more, since Region A utilizes a first currency (e.g., Euros in this example, etc.), and Region B utilizes a second currency (e.g., US dollars, etc.), Transaction A also involves a currency exchange. With that said, it should be appreciated that not all intercountry transactions are necessarily cross-border transactions for fee purposes. For example, in Europe, extended Eurozone transactions involving different countries may be excluded from treatment as cross-border transactions.

In turn, in Transaction A in this example, the merchant 102a reads the payment device and/or otherwise receives payment account information from the consumer and communicates an authorization message 114 (e.g., an authorization request, etc.) to the acquirer 104a, as shown in FIG. 1, along path A. As shown, the authorization message 114 is segmented into different data elements, where each of the data elements includes information pertinent to and/or associated with the transaction such as, for example, a name of the consumer, a primary account number (PAN) for the consumer's payment account, an amount of the transaction (e.g., DE4=100, etc.), a currency for the transaction (e.g., DE49=Euros, etc.), an expiration date for the payment device, a card verification code (CVC) associated with the payment device, a terminal ID associated with the merchant 102a, a merchant ID for the merchant 102a, a name of the merchant 102a, a location of the merchant 102a, a processing code for the transaction, a transaction type for the transaction (e.g., card-present, card-not-present, etc.), etc.

Next, the acquirer 104a communicates the authorization message 114 through the payment network 106 (e.g., through MasterCard®, VISA®, Discover®, American Express®, etc.) to the issuer 108. The issuer 108 then determines whether the transaction should be approved, for example, based on whether the payment account associated with the consumer is in good standing and includes sufficient funds and/or credit to cover the transaction. In response thereto, the issuer 108 transmits an authorization message (e.g., authorization reply, etc.) back, along path A, to merchant 102a (either approving or declining the transaction), which permits the merchant 102a to complete the transactions, or, potentially, when declined, request alternative payment.

Similarly, for another exemplary transaction, the consumer initiates a transaction at the merchant 102b, which is a gambling establishment and associated with MCC 7995 (Gambling Transactions) (referred to herein as Transaction B). The transaction is originated in U.S. dollars, for an amount of 100 US dollars. Consistent with the above, the merchant 102b again reads the consumer's payment device and/or otherwise receives payment account information from the consumer for his/her payment account, and communicates an authorization message to the acquirer 104b (i.e., the acquirer associated with the merchant 102b), as shown in FIG. 1 by reference to path B (in a similar manner to above). The acquirer 104b, in turn, communicates the authorization message through the payment network 106 (e.g., through MasterCard®, VISA®, Discover®, American Express®, etc.) to the issuer 108 in Region C. As such, Transaction B is a cross-border transaction. That said, the issuer 108 settles transactions in USD and the consumer's payment account is billed in USD. Accordingly, Transaction B does not involve a currency conversion. In response to the authorization request, the issuer 108 then again determines whether the transaction should be approved, for example, based on whether the payment account associated with the consumer is in good standing and includes sufficient funds and/or credit to cover the transaction. After, the issuer 108 transmits an authorization reply back, along path B, to merchant 102b, which permits the merchant 102b to complete the transactions, or, potentially, when declined, request alternative payment.

For each of the exemplary transactions above, the transactions are later settled by and between the involved parts of system 100, generally, in combination with multiple other transactions involving the acquirers 104a-b and/or issuer 108 (via various settlement and/or clearing messages, etc.). In particular, for example, the merchant 102a sends (e.g., via a clearing message, etc.) its payment account transactions to the acquirer 104a at the end of the day or within a predefined interval. This includes information for each transaction associated with the merchant 102a, including, for example, an account number or other ID, an amount of the transaction, a merchant name, a merchant ID, a merchant location, a transaction type, etc. (broadly, transaction data). In turn, the acquirer 104a reconciles each of the transactions and passes them on to the payment network 106 (as clearing records or messages, including a record for each transaction), etc. Likewise, the acquirer 104b and the issuer 108 provide clearing records to the payment network 106. The payment network 106 then generates a clearing order, based on the clearing records received from each of the acquirers 104a-b and the issuer 108, and settles the transactions by debiting funds from appropriate accounts at the issuer 108 (as defined by clearing records received from the acquirer 104a) and crediting the funds to accounts associated with the acquirer 104a (e.g., for merchant 102a, etc.) for the net amount of the transactions. The issuer 108 then records the transactions against the accounts issued to its consumers (including the account for the consumer in the above examples), while the acquirers 104a-b record the transactions against the appropriate merchant's account.

It should be appreciated that various other transactions may be associated with the consumer's payment account, and that are different than the specific description above. For example, a transaction may include a return payment account transaction, whereby the consumer is attempting to return a product or products to one of the merchants 102a-b, in exchange for a refund through the payment account, or in exchange for cash. In addition, a transaction may include an ATM cash withdrawal or a cash disbursement, etc. (e.g., where one or both the merchants 102a-b includes an ATM, etc.). Thus, while different transactions to the consumer's payment account may depart from the examples described above with respect to FIG. 1 (e.g., an ATM withdrawal may not necessarily include the merchant 102a, etc.), the transactions will generally follow the paths (e.g., path A or path B, etc.) outlined in FIG. 1 (even if limited or involving different parts of the system 110 or other parts not shown), and/or may (or may not) involve cross-border transactions and/or currency conversion transactions, and/or result in funds being debited from or added to different accounts. Accordingly, various other transactions may be subject to the operations described herein, even though not expressly described.

Transaction data is generated, collected, and stored as part of the above exemplary interactions among the merchants 102a-b, the acquirers 104a-b, the payment network 106, the issuer 108, and the consumer. The transaction data includes a plurality of transaction records, one for each transaction, or attempted transaction. The transaction records, in this exemplary embodiment, are stored at least by the payment network 106 (e.g., in a data structure associated with the payment network 106, etc.) (e.g., as authorization messages, clearing messages or records, etc.). In particular, in the system 100, the payment network 106 stores the transaction data (and associated records) in a transaction data structure 118. As generally described above, the transaction records may include, for example, payment account numbers or other IDs, amounts of transactions, merchant names, merchant IDs, merchant locations, transaction types, transaction channels, dates/times of the transactions, currency codes, country codes, merchant category codes (MCCs), processing codes or other suitable dimensions of a transaction, as described below, or otherwise, etc. (broadly, transaction data). It should be appreciated that more or less information related to transactions, as part of either authorization or clearing and/or settling, may be included in transaction records and stored within the system 100, at the merchants 102a-b, the acquirers 104a-b, the payment network 106, and/or the issuer 108.

In the embodiments herein, consumers involved in the different transactions are prompted to agree to legal terms associated with their payment accounts, for example, during enrollment in their accounts, etc. In so doing, the consumers voluntarily agree, for example, to allow merchants, issuers, payment networks, etc., to use transaction data generated and/or collected during enrollment and/or in connection with processing the transactions, for subsequent use in general, and as described herein.

It should be appreciated that while only two merchants 102a-b, two acquirers 104a-b, one payment network 106, and one issuer 108, along with one border line 112, are included in the system 100, other system embodiments will generally include multiple of each of the parts, with interactions, as described above, by and between the parts.

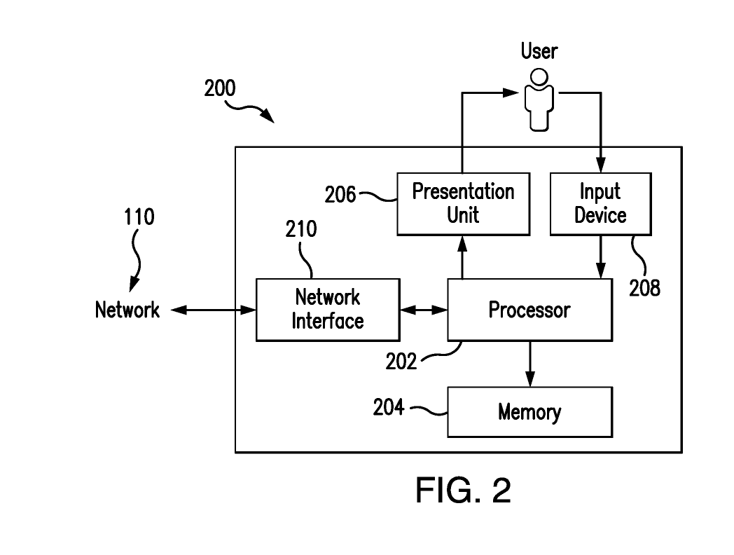

FIG. 2 illustrates an exemplary computing device 200 that can be used in the system 100. The computing device 200 may include, for example, one or more servers, workstations, personal computers, laptops, tablets, smartphones, PDAs, etc. In addition, the computing device 200 may include a single computing device, or it may include multiple computing devices located in close proximity or distributed over a geographic region, so long as the computing devices are specifically configured to function as described herein. In the exemplary system 100 of FIG. 1, each of the merchants 102a-b, the acquirers 104a-b, the payment network 106, and the issuer 108 are illustrated as including, or being implemented in, computing device 200, coupled to (and in communication with) the network 110. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured, as one or more data structures, to store, without limitation, transaction data (e.g., merchant names/IDs, merchant locations, account IDs, amounts spent, transaction types, currency codes, country codes, processing codes, etc.), country listings, fee schedules, cross-border fees, exchange-rate fees, dimension values associated with transactions, and/or other types of data (and/or data structures) suitable for use as described herein. Furthermore, in various embodiments, computer-executable instructions may be stored in the memory 204 for execution by the processor 202 to cause the processor 202 to perform one or more of the operations described herein, such that the memory 204 is a physical, tangible, and non-transitory computer-readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., fee schedules, transaction data, etc.), visually, for example, to a user of the computing device 200. It should be further appreciated that various interfaces (e.g., as defined by internet-based applications, websites, etc.) may be displayed at computing device 200, and in particular at presentation unit 206, to display certain information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, selections of certain fees from issuer fee schedules, etc.), etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, etc. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 includes an assessment engine 116 specifically configured, by executable instructions, to operate as described herein. The assessment engine 116 is illustrated as a standalone part of the system 100 and, in this manner, may be considered one or more computing devices consistent with computing device 200. Additionally, or alternatively, the assessment engine 116, as indicated by the dotted line in FIG. 1, may be integrated, in whole or in part, with the payment network 106 (e.g., as part of the computing device 200 associated therewith, etc.). In addition, the assessment engine 116 is coupled to the data structure 118, which may be standalone from the assessment engine 116 of integrated in whole, or in part, with the engine 116 (and by extension with the payment network 106, when the assessment engine 116 is integrated therein). In other embodiments, the assessment engine 116 may be integrated in whole or in part with the issuer 108 (e.g., as part of the computing device 200 associated therewith, etc.).

In this exemplary embodiment, the data structure 118 includes multiple different fee schedules, each specific to an issuer (e.g., the issuer 108, etc.). An exemplary fee schedule specific to the issuer 108 is illustrated in Tables 1 and 2.

Table 1 illustrates a portion of the exemplary fee schedule specific to currency conversion fees for the issuer 108. As shown, the illustrated portion of the fee schedule is segregated based on the different dimensions of a transaction, with a fee identified to each of the combinations and/or permutations of the dimensions. Specifically, for example, the portion of the fee schedule in Table 1 distinguishes fees based on a region differentiator (broadly, the location of the transaction) (e.g., Intra SEPA/Intra non SEPA, Inter SEPA/non SEPA, etc.), a type of transaction (e.g., Card Present, Card Not Present, etc.), and a processing code (e.g., ATM Cash Withdrawal, Payment Transaction, etc.) (e.g., included at data element (DE) 3, subfield 1 of the authorization request, etc.). In this example, for a transaction by a consumer at a merchant using a payment account issued by the issuer 108, where a value of the region differentiator is “Intra SEPA,” a value of the transaction type is “Card Present,” and a value of the processing code indicates “ATM Cash Withdrawal,” the issuer currency conversion rate is 1.0% (and/or a fixed rate of 0.1 US dollars). Similarly, for another transaction where a value of the region differentiator is “Intra SEPA,” a value of the transaction type is “Card Not Present,” and a value of the processing code indicates “Unique transaction” (e.g., transactions characterized by specific MCCs (e.g., Gambling, Quasi cash, etc.), etc.), the issuer currency conversion rate may be fixed at 3.0 US dollars (and/or at a rate of 2.1%).

TABLE 1

| | | | | Issuer | Issuer |
|---|---|---|---|---|---|
| | | | | Currency | Currency |
| | | | | Conversion | Conversion |
| Dimensions | | | | Rate % | Rate Fixed |
| Currency | Intra | Card | DE3 = ‘01’ ATM Cash | 1.0 | 0.1 |
| Converted | SEPA/Intra | Present | Withdrawal | Max 2 | |
| | non SEPA | | DE3 = ‘28’ Payment | 2.0 | 0.2 |
| | | | Transaction | | |
| | | | DE3 = ‘09’ Purchase Cashback | 1.2 | 0.1 |
| | | | DE3 = ‘18’ Unique | 1.0 | 0.1 |
| | | | transactions | | |
| | | | DE3 = ‘20’ Credit (Purchase | 1.0 | 0.2 |
| | | | Return) | | |
| | | | DE3 = ‘12’ Cash | 2.0 | 0.1 |
| | | | Disbursement | | |
| | | | DE3 = ‘00’ Purchase | | |
| | | Card | DE3 = ‘00’ Purchase | 1.1 | 0.01 |
| | | Not | DE3 = ‘18’ Unique | 2.1 | 3.0 |
| | | Present | transactions | | |
| | | | DE3 = ‘20’ Credit (Purchase | 3.1 | 0.1 |
| | | | Return) | | |
| | Inter | Card | DE3 = ‘01’ ATM Cash | 1.9 | 3 |
| | SEPA/non | Present | Withdrawal | | |
| | SEPA | | DE3 = ‘28’ Payment | 1.0 | 0.1 |
| | | | Transaction | | |
| | | | DE3 = ‘09’ Purchase Cashback | 0.4 | 0.2 |
| | | | DE3 = ‘18’ Unique | 0.2 | 0.2 |
| | | | Transactions | | |
| | | | DE3 = ‘20’ Credit (Purchase | 1.1 | 0.1 |
| | | | Return) | | |
| | | | DE3 = ‘12’ Cash | 1.0 | 0.2 |
| | | | Disbursement' | | |
| | | | DE3 = ‘00’ Purchase | 2.0 | 0.1 |
| | | Card | DE3 = ‘00’ Purchase | 1.1 | 0.1 |
| | | Not | DE3 = ‘18’ Unique transactions | 1.1 | 0.1 |
| | | Present | DE3 = ‘20’ Credit (Purchase | 1.1 | 0.2 |
| | | | Return) | | |

Table 2 illustrates a portion of the exemplary fee schedule specific to cross-border fees for the issuer 108. Again, the illustrated portion of the fee schedule is segregated based on the different dimensions of a transaction, with a fee identified to each of the combinations and/or permutations of the dimensions (e.g., a region differentiator (broadly, the location of the transaction) (e.g., Intra SEPA/Intra non SEPA, Inter SEPA/non SEPA, etc.), a type of transaction (e.g., Card Present, Card Not Present, etc.), and a processing code (e.g., ATM Cash Withdrawal, Payment Transaction, etc.), etc.).

TABLE 2

| | | | | Issuer Cross | Issuer Cross | Issuer Cross |
|---|---|---|---|---|---|---|
| | | | | border Markup | Border Markup | Border Assessment |
| Dimensions | | | | % (ICBM) | Fixed (ICBM) | ICBA Rate % |
| Cross | Intra | Card | DE3 = ‘01’ ATM | 1.1 | 2 | 0.1 |
| Border | SEPA/ | Present | Cash Withdrawal | | | |
| | Intra | | DE3 = ‘28’ Payment | 1.2 | 2 | 0.1 |
| | non | | Transaction | | | |
| | SEPA | | DE3 = ‘09’ Purchase | 1.1 | 3 | 0.1 |
| | | | Cashback | | | |
| | | | DE3 = ‘18’ Unique | 1.2 | 2 | 0.1 |
| | | | Transaction | | | |
| | | | DE3 = ‘20’ Credit | 1.4 | 2 | 0.1 |
| | | | (Purchase Return) | | | |
| | | | DE3 = ‘12’ ‘Cash | 1.5 | 1 | 0.1 |
| | | | Disbursement’ | | | |
| | | | DE3 = ‘00’ Purchase | 1.2 | 1 | 0.1 |
| | | Card | DE3 = ‘00’ Purchase | 1.1 | 1 | 0.1 |
| | | Not | DE3 = ‘18’ Unique | 1.5 | 2 | 0.1 |
| | | Present | Transaction | | | |
| | | | DE3 = ‘20’ Credit | 1.6 | 2.4 | 0.1 |
| | | | (Purchase Return) | | | |
| | Inter | Card | DE3 = ‘01’ ATM | 1.2 | 3 | 0.5 |
| | SEPA/ | Present | Cash Withdrawal | | | |
| | non | | DE3 = ‘28’ Payment | 1.3 | 2 | 0.5 |
| | SEPA | | Transaction | | | |
| | | | DE3 = ‘09’ Purchase | 1.5 | 1 | 0.3 |
| | | | Cashback | | | |
| | | | DE3 = ‘18’ Unique | 1 | 2 | 0.2 |
| | | | Transaction | | | |
| | | | DE3 = ‘20’ Credit | 1 | 3 | 2 |
| | | | (Purchase Return) | | | |
| | | | DE3 = ‘12’ ‘Cash | 1.2 | 2 | 2 |
| | | | Disbursement' | | | |
| | | | DE3 = ‘00’ Purchase | 1.3 | 2 | 2 |
| | | Card | DE3 = ‘00’ Purchase | 1.2 | 2 | 2 |
| | | Not | DE3 = ‘18’ Unique | 1.1 | 2 | 2 |
| | | Present | Transaction | | | |
| | | | DE3 = ‘20’ Credit | 1.5 | 3 | 3 |
| | | | Purchase Return | | | |

It should be appreciated that the example dimensions included in Tables 1 and 2, and others discussed herein, may be used in various embodiments, by the issuer 108, to set fees for transactions based on values of the dimensions or combinations of values for different dimensions. However, the present disclosure is not limited to the specific dimensions illustrated in Tables 1 and 2. In addition, as can be appreciated by the example fee schedules above, fees may include a percentage fee (or rate) of the given transaction such as, for example, 0.2%, etc. Or alternatively, or additionally (as above), fees may include a fixed fee associated with the identified dimension of the transaction, type of the transaction, and/or processing code, such as, for example, 1.50 US dollars, etc. The percentage fees and the fixed fees may be employed separately or in combination, as desired by the issuer 108 and/or permitted by the assessment engine 116, etc.

It should further be appreciated that the fees assessed based on the tables above, and other tables, are defined by the issuer 108 (and/or other issuers) and that the fees are collected by the respective issuers (or other suitable entities). The payment network 106 merely provides, as described herein, the ability to adjust the fees, for example, based on risks or otherwise, with the fees being reconciled in connection with the clearing and settlement processes and paid to the issuers and/or other suitable entities.

It should also be appreciated that different dimensions and/or different combinations of dimensions of transactions may be employed in other fee schedules, whereby fees may be more or less segregated by one or more of the same and/or different dimensions. In at least one embodiment, a merchant category code (MCC) may be used to distinguish between two or more fees in the fee schedule. For example, transactions having a processing code of “18,” to designate the transaction as a unique transaction, and involving MCC 4829 (Money Transfer), MCC 6050 (Quasi Cash Financial Institution), MCC 6051 (Quasi Cash-Merchant), MCC 6538 (MoneySend Funding), MCC 7801 (Internet Gambling), MCC 7802 (Government Licensed Horse/Dog Racing), and MCC 7995 (Gambling Transactions), etc. may be deemed to be more risky than other transactions, whereby a different fee or fees may be associated therewith (e.g., with the category/processing code “18” in general versus other such codes, or with each particular MCC included in category/processing code “18” having a particular fee for fees; etc.). In another embodiment, a dimension may include a payment account brand, where the assessment engine 116 may be configured to identify the value of the payment account brand based on a range associated with the PAN of the payment account involved in the underlying transaction.

In this exemplary embodiment, the assessment engine 116 is configured to, generally, permit the issuer 108 (and other issuers in the system 100) to define one or more fees associated with transactions involving payment accounts issued by the issuer 108 (e.g., via the fee schedule of Tables 1 and 2, etc.), based on the dimensions of the transactions, and either to advise the issuer 108 of the one or more fees or to impose the one or more fees on transactions (e.g., as part of the transaction at authorization or clearing, etc.). In connection therewith, the assessment engine 116 is configured to solicit the one or more fees as associated with one or more of the different dimensions from the issuer 108. The issuer 108 then provides the fees, as desired and/or required thereby, whereupon, the assessment engine 116 is configured to receive the fees associated with the one or more different dimensions and to store the fees in the fee schedule (in the data structure 118, etc.), as defined by the dimensions.

In addition, the issuer 108 may provide, to the assessment engine 116, an instruction to impose the one or more fees at authorization (e.g., as an advisement, etc.), at clearing, or both, as described in more detail below. In turn, the assessment engine 116 is configured to then receive the instruction(s) and to store the instruction(s) along with the fee schedule.

Subsequently, after a consumer attempts a transaction, the transaction is provided to the payment network 106 at authorization of the transaction (e.g., in the form of an authorization request or message), and in clearing (e.g., in the form of a clearing record or message), etc. In response to the transaction, for example, at authorization, the assessment engine 116 is configured to identify and to also, optionally, intercept the transaction, thereby inhibiting the authorization request from proceeding to the issuer 108. In response to the transaction, for example, at clearing, the assessment engine 116 is merely configured to identify the transaction. In either manner, the assessment engine 116 is configured to identify the transaction, for example, based on the primary account number or PAN included therein being within a range of PANs, etc. The PAN range(s) may be indicative of application of cross border fees, currency exchange fees, and/or other fees, or combinations thereof.

Thereafter, the assessment engine 116 is configured to retrieve the fee schedule for the issuer 108 from the data structure 118.

The assessment engine 116 is configured to then determine if the transaction is a cross-border transaction and subject to a cross-border fee and/or is a currency exchange transaction and subject to a currency exchange fee. In connection therewith, the assessment engine 116 is configured to identify a value for each of the dimensions included in the fee schedule for the issuer 108, for example, by accessing the data elements (DE) included in the transaction (e.g., in the authorization message or the clearing record or message, etc.) and their corresponding processing codes (e.g., DE3 and the processing code indicated therein, etc.). The assessment engine 116 is configured to then select one or more fees in the fee schedule for the issuer 108, when the dimension(s) of the transaction (i.e., values thereof) match particular dimensions included in the fee schedule.

Once selected (and when the instruction is for assessment only at authorization, for example), the assessment engine 116 is configured to append the fees to the authorization message in an empty data element and then to release the authorization request, as is described above with reference to path A and B in FIG. 1, whereby the one or more fees are received by the issuer 108 as an advisement. The issuer 108 may then impose the one or more fees of the account involved in the transaction (without further participation of the assessment engine 116, as to the fees, etc.). Alternatively (when the instruction is for assessment at authorization and clearing), the assessment engine 116 is configured to apply the fees to the intercepted authorization request (e.g., by adjusting the amount to include the one or more fees and/or otherwise included the one or more fees in the transaction, etc.) prior to releasing the authorization request to the issuer 108. In this manner, the one or more fees become part of the transaction (at authorization) and are later cleared and settled along with the transaction.

As a further alternative (when the instruction is for assessment only at clearing), the assessment engine 116 is configured to include the fee(s) in the clearing and/or settlement records or messages associated with the transaction. The record, therefore, may be associated with the issuer 108 (e.g., fee collection account associated with the issuer 108, etc.), the consumer's account at the issuer, and/or the appropriate one of the acquirers 104a-b, depending on which one of the merchants 102a-b is involved in the transaction. The clearing record is then used to clear and settle the transactions, whereby the fees will be provided to the issuer 108 and funded by the account associated with the consumer initiating the transaction, while the funds of the transactions are then transferred to the accounts indicated by the transactions.

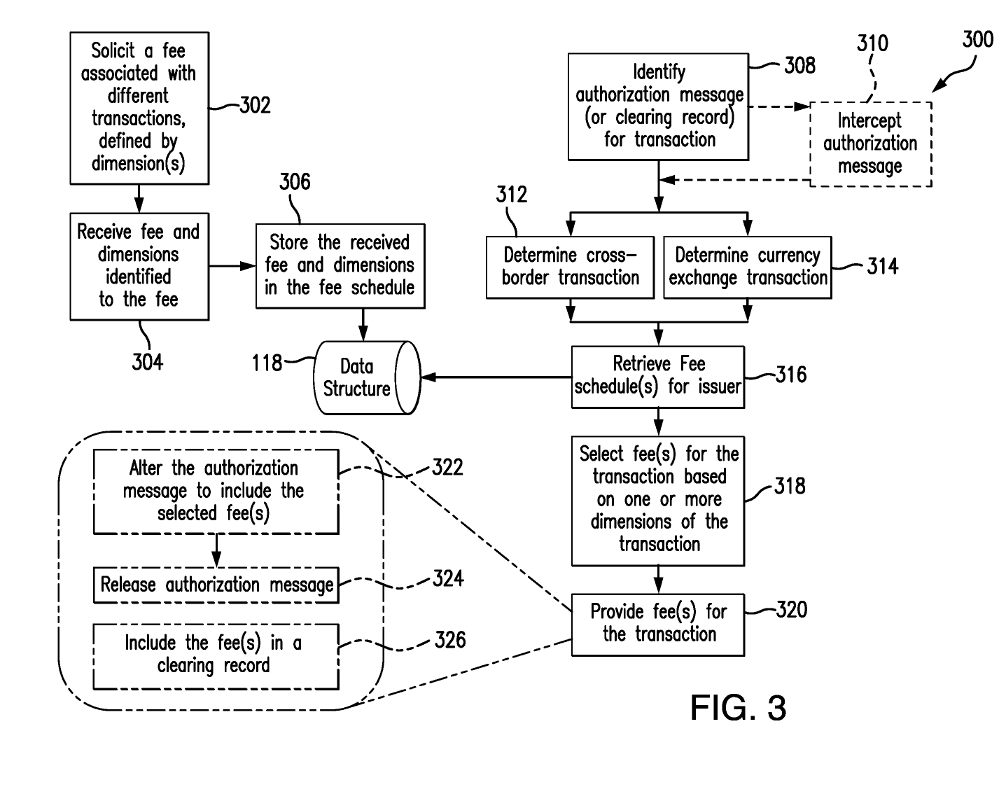

FIG. 3 illustrates an exemplary method 300 for assessing fees in connection with payment account transactions. The exemplary method 300 is described as implemented in the assessment engine 116 of the system 100, with additional reference to the other parts thereof. However, the method 300 is not limited to the assessment engine 116, or more generally, to the system 100. Further, the exemplary method 300 is described herein with reference to the computing device 200. But the methods herein should not be understood to be limited to the exemplary computing device 200. Likewise, the systems and computing devices herein should not be understood to be limited to the exemplary method 300.

The method 300 is also described with reference to the two exemplary transactions (i.e., Transaction A and Transaction B) described above in the system 100, and as described in connection with path A and path B of FIG. 1. That said, however, it should be appreciated that different transactions originating from different parts of the system 100 may be subject to the method 300, substantially as described below.

As shown in FIG. 3, when the issuer 108 opts to participate in services provided by the assessment engine 116 for assessing fees to transactions as described herein, and/or periodically thereafter, the assessment engine 116 solicits from the issuer 108, at 302, a fee (or multiple different fees) associated with different transactions. In general, the assessment engine 116 will solicit one or more fees contemplated and/or desired by the issuer 108 for certain dimensions of the transactions. The one or more fees may be provided as percentages (e.g., as percentages of the transaction amounts involved, etc.), or as fixed fees, or as combinations thereof, as indicated above. In providing the fees, the issuer 108 may specify which form to use, or the assessment engine 116 may do so independently.

In addition, the assessment engine 116 also solicits from the issuer 108, at 302, the dimensions identified by the fees (e.g., the particular transaction dimensions to which particular fees apply, etc.). As described above with reference to the fee schedule for the issuer 108 and illustrated in Tables 1 and 2, the dimensions may include for example, region differentiators, transaction types, processing codes, MCCs, etc.

As an example, a region differentiator dimension for a transaction may include a SEPA designation for the origin of the transaction, where a value of the region differentiator indicates whether the transaction originates from an intra SEPA or non SEPA country or an inter SEPA or non SEPA country (e.g., as determined in a data structure based on the location of the transaction, etc.). Of course, different region differentiators, related to different regions and/or segregations or divisions of regions, may be employed in other embodiments. The transaction type dimension for a transaction, in this example, generally indicates whether the card is present, or not present at the transaction (as indicated in one or more data elements of the authorization message for the transaction). Likewise, for example, the processing code dimension of a transaction generally indicates whether the transaction is, for example, a payment transaction, a cash withdrawal, a purchaser cashback, a credit, or other transactions (e.g., as indicated in Tables 1 and 2, etc.) (as indicated in one or more data elements of the authorization message for the transaction, including, e.g., from DE3).

And, also for example, as indicated above (but not included in the fee schedule of Tables 1 and 2), the MCC dimension of a transaction may be used in various embodiments by the issuer 108 to segregate and/or assign fees for the transaction. In this exemplary embodiment, the MCC dimensions are employed in combination with a particular processing code (e.g., processing code “18” for unique transaction, etc.), or otherwise, whereby when the processing code is “18” one or more fees may be based on the MCC of the transaction (but not based on the MCC when the processing code is otherwise). But this is not required in all embodiments.

When the issuer 108 provides the solicited fees and/or dimensions, the assessment engine in turn receives, at 304, the fees and the corresponding dimensions identified to the fees and then, at 306, stores the received fees (along with the dimensions, as needed) in a fee scheduled associated with the issuer 108, in the data structure 118.

In addition, apart from the fee schedule indicating the fees to be assessed, the issuer 108 may have the option to determine when to impose the fees as part of the authorization, as part of clearing, as part of both, or as neither, with the issuer 108 instead receiving an advisement. As part of the above solicitation of fees, optionally (not shown), the issuer 108 may further indicate an instruction for when/if one or more fees are to be assessed, by the assessment engine 116, against a transaction. In the context of FIG. 3, initially, the issuer 108 has instructed assessment at authorization only. But again, this is exemplary in nature, and the fees may instead be assessed against a transaction at clearing, at combinations of authorization and clearing, etc.

Based on the above, from time to time, a consumer may attempt a transaction using a payment account issued by the issuer 108. For example, as described above in the system 100, the consumer may desire to purchase a product for 100 Euros from the merchant 102a (referred to herein as Transaction A). In response, an authorization message is compiled by the merchant and transmitted to the acquirer (e.g., the acquirer 104a, etc.), which, in turn, directs it to the issuer 108, via the payment network 106.

In connection therewith, the assessment engine 116 identifies the authorization message for the transaction, at 308. The authorization message is identified, for example, based on a PAN included in the authorization message, where the PAN is included in a range of PANs associated with the issuer 108 and/or associated with one or more particular fees and/or fee schedules by the issuer 108. In this exemplary embodiment, the assessment engine 116 optionally (as indicated by the dotted lines) intercepts, at 310, the authorization message for the transaction. By intercepting the authorization request, the assessment engine 116 essentially inhibits the authorization message (and more broadly, the transaction) from proceeding until processed as described herein.

The assessment engine 116 then determines, at 312, based on the data associated with the transaction (e.g., data elements included in the authorization request, etc.) whether the transaction involves a cross-border transaction, and also determines, at 314, whether the transaction involves a currency exchange/conversion. In doing so, the assessment engine 116 may rely on the country codes for the involved acquirer (e.g., acquirer 104a, etc.), PAN, associated institutions (e.g., forwarding, receiving, settlement institutions, etc.), etc., included in the authorization message, and/or the currency codes associated with the transaction, settlement, cardholder billing, etc. With reference to the exemplary Transaction A described above in the system 100 (with reference to path A in FIG. 1), the assessment engine 116 determines that the country code in the authorization request is associated with a country different than that of the issuer 108, and that the transaction currency code is different than the billing currency code for the issuer 108. As such, Transaction A is determined to be both a cross-border transaction and a currency exchange transaction.

Thereafter, in the method 300, the assessment engine 116 identifies the issuer 108 (e.g., based on the authorization message, etc.) and retrieves the fee schedule(s) for the issuer 108 from the data structure 118, at 316, for both cross-border fees and currency exchange fees. The assessment engine 116 further selects, at 318, fee(s) for the transaction based on one or more dimensions of the transaction (e.g., as determined from the values for the dimensions included in the authorization message, etc.). With reference to Table 1, and Transaction A, for example, the assessment engine 116 identifies from the authorization message that the value for the region differentiator is Intra SEPA (e.g., based on the country code of the merchant involved in the transaction and a correlation in a region differentiator data structure (e.g., as part of the data structure 118, etc.), etc.), that the value for transaction type is “Card Present” (e.g., DE22SF6=1 for the card being present, as opposed to DE22SF6=0 for a card not present transaction; etc.), and that the value of the processing code is “28” at DE3 indicating a payment transaction. As such, per the fee schedule of Table 1, the assessment engine 116 selects a fee for the currency exchange of 2% of the transaction, i.e., 2 Euros (100 Euros×0.02), which is then applied in the billing currency of the transaction, i.e., US dollars in this example (since the currency associated with the account issued to the consumer by the issuer 108 in Region C is US dollars). In addition, or alternatively, the assessment engine may select the fixed rate for the currency exchange of 0.2 US dollars and similarly apply it to the transaction.

In addition, the assessment engine 116, for Transaction A, at 316, retrieves the fee schedule of Table 2 for the issuer 108 (because it determined Transaction A was also a cross-border transaction). Consistent with the above, the assessment engine 116 then selects, at 318, the fee for the cross-border transaction, which is 1.2% of the transaction, i.e., 1.2 Euros (100 Euros×0.012), which again is applied in the billing currency of the transaction, i.e., US dollars in this example. The cross-border fee is then applied in combination with the currency exchange fee for the transaction. In addition, or alternatively, the assessment engine may select the fixed rate for the currency exchange of 2 US dollars and similarly apply it to the transaction.

Next, after selecting fee(s) totaling 3.2 Euros, for Transaction A, the assessment engine 116 provides, at 320, the fee(s) for the transaction (again, in US dollars). In this example, because it was initiated from the authorization request (which was intercepted), the assessment engine 116 provides the fee(s) by including the fee(s) in the authorization request, in un-used data elements thereof. Broadly, the assessment engine 116 alters, at 322, the authorization message to include the selected fee(s) and then releases the authorization message to the issuer 108, at 324. In particular, in this example (based on an authorization only instruction from the issuer 108 in this example), the assessment engine 116 appends the selected fees to one or more un-used data elements of the authorization message, thereby providing an advisement to the issuer 108 of the fee(s) to be imposed for the transaction. Here, again, based on the authorization only instruction from the issuer 108, the assessment engine 116 takes no further action to impose the selected fee(s) on the accounts involved in the transaction (e.g., though clearing, etc.).

Conversely, for an instruction to assess fees at authorization and clearing, at 322, the assessment engine 116 alters the authorization message by imposing the selected fee(s) as part of the amount of the transaction (e.g., the transaction amount for Transaction A would be 103 Euros, etc.), as described above. In addition, the assessment engine 116 may also include the selected fee(s) in un-used data element of the authorization message to inform the issuer 108 on the included fees and specific amount per fee, as also described above. Once altered, the authorization message is then released, at 324 to proceed to the issuer 108. The transaction is then cleared and settled as described above, in this example, with the assessment engine 116 also imposing the fees. It should be appreciated that certain additional advisements, notations, and/or entries in clearing and/or settlement may be provided to account for the fee(s) and/or provide for disposition to the issuer 108.

With continued reference to FIG. 3, and with reference to Transaction B, if the issuer 108 provides an instruction for assessment at clearing only, the assessment engine 116 identifies, at 308, the clearing record for the transaction, when the transaction is submitted by the issuer 108 and/or the acquirer 104b for clearing and settlement. That is, the assessment engine 116 permits the authorization message for the transaction to pass, as described above, without intercepting or otherwise identifying the same. Consistent with the above, the clearing record is identified, at 308, based on the PAN included therein and/or a PAN range associated with the PAN.

Once identified, as above, the assessment engine 116, based on the data included in the clearing record, determines whether the transaction involves a cross-border transaction, at 312, and also determines whether the transaction involves a currency exchange/conversion, at 314. With reference specific to the exemplary Transaction B described above in the system 100 (with reference to path B in FIG. 1), the assessment engine 116 determines that the country code of the merchant 102b involved in the transaction is associated with a country different than that of the issuer 108 (based on different country codes included in the clearing record for the merchant 102b and the issuer 108), but that the transaction currency code is same as the billing currency code for the issuer 108 (as also included in the clearing record). As such, Transaction B is determined to be a cross-border transaction (but not a currency exchange transaction).

Thereafter in the method 300, the assessment engine 116 retrieves the fee schedule for the issuer 108 from the data structure 118, at 316, for cross-border fees. The assessment engine 116 further selects, at 318, the fee for the transaction based on one or more dimensions of the transaction (e.g., as determined from the values for the dimensions included in the clearing record, etc.). With reference to Table 2, and Transaction B, the assessment engine 116 identifies that the value for the region differentiator is Inter SEPA (e.g., based on the county code of the merchant involved in the transaction, etc.), that the value for transaction type is “Card Not Present” at DE22, and that the processing code is “18” at DE3 indicating a unique transaction (based on an MCC of 7995 (Gambling Transaction) for the transaction, for example). As such, per the fee schedule of Table 2, the assessment engine selects a fee of 1.5% for the cross-border transaction, i.e., 1.5 US dollars (100 US dollars×0.015), which is then applied in the billing currency of the transaction, i.e., US dollars.

Next, after selecting the fee for Transaction B, the assessment engine 116 provides, at 320, the fee for the transaction. In this example, because it was initiated from the clearing record, the assessment engine 116 provides the fee by including, at 326, the fee in the clearing record for the issuer 108 and the acquirer 104b. Specifically, the clearing record indicates a transfer from the consumer's account to the merchant's account for $100 US dollars and a transfer from the consumer's account to an issuer fee account for 1.5 US dollars. The payment network 106 then generates a clearing order, based on the clearing records received from each of the acquirers 104a-b and the issuer 108 and settles the transactions (including the example Transaction B). It should be appreciated that certain additional advisements, notations, and/or entries in clearing and/or settlement may be provided to account for the fee and/or provided for disposition to the issuer 108.

In view of the above, the systems and methods herein may permit issuers to impose fee(s), based on specific dimensions of a transaction, when the transaction includes a cross-border and/or currency exchange transaction.

Again and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by: (a) identifying a transaction associated with a payment account, the payment account associated with a consumer and issued by an issuer; (b) retrieving a fee schedule for the issuer, the fee schedule including multiple fees, each of the multiple fees associated with the issuer and identified to at least one transaction dimension, the multiple fees including cross-border fees and/or currency exchange fees; (c) selecting at least one fee for the transaction from the multiple fees in the fee schedule based on at least one transaction dimension of the identified transaction; and (d) providing the selected at least one fee for the identified transaction, whereby the at least one fee is assessed to the payment account for payment by the consumer.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in assessing fees associated with payment account transactions, the method comprising:
identifying, by at least one computing device, a transaction associated with a payment account, the payment account associated with a consumer and issued by an issuer;
retrieving, by the at least one computing device, a fee schedule for the issuer, the fee schedule including multiple fees, each of the multiple fees associated with the issuer and identified to at least one transaction dimension, the multiple fees including cross-border fees and/or currency exchange fees;
selecting, by the at least one computing device, at least one fee for the transaction from the multiple fees in the fee schedule based on at least one transaction dimension of the identified transaction; and
providing, by the at least one computing device, the selected at least one fee for the identified transaction, whereby the at least one fee is assessed to the payment account for payment by the consumer.

2. The computer-implemented method of claim 1, wherein the at least one transaction dimension includes multiple transaction dimensions, and wherein the fee schedule includes a fee associated with each of multiple unique combinations of the multiple transaction dimensions; and
wherein the multiple transaction dimensions include a processing code and a transaction type.

3. The computer-implemented method of claim 2, wherein the multiple transaction dimensions further include a region differentiator and/or a payment account brand; and
wherein the transaction type indicates a card-not-present or a card-present designation.

4. The computer-implemented method of claim 1, wherein identifying the transaction includes identifying an authorization message associated with the transaction; and
wherein the method further comprises intercepting the identified authorization message; and
wherein providing the selected at least one fee includes altering the identified authorization message to include the selected at least one fee, prior to releasing the authorization message to the issuer.

5. The computer implemented method of claim 1, wherein identifying the transaction includes identifying a clearing message associated with the transaction; and
wherein providing the selected at least one fee includes including the selected at least one fee in the clearing message associated with the transaction.

6. The computer implemented method of claim 1, further comprising determining, by the at least one computing device, that the identified transaction is a cross-border transaction; and
wherein selecting the at least one fee is further based on the determination that the transaction is a cross-border transaction.

7. The computer implemented method of claim 1, further comprising determining, by the at least one computing device, that the transaction involves a currency exchange; and
wherein selecting the at least one fee is further based on the determination that the transaction involves a currency exchange.

8. The computer implemented method of claim 1, wherein identifying the transaction includes intercepting an authorization message associated with the transaction; and
wherein providing the selected at least one fee includes altering the authorization message to include the at least one fee in a total amount of the transaction.

9. A non-transitory computer-readable storage media including executable instructions for assessing fees in connection with payment account transactions, which when executed by at least one processor, cause the at least one processor to:
identify a transaction to a payment account, the payment account issued by an issuer;
retrieve a fee schedule for the issuer from memory associated with the at least one processor based on the issuer, the fee schedule including multiple fees, each of the multiple fees associated with the issuer and identified to multiple different transaction dimensions;
select, in the fee schedule for the issuer, at least one fee for the transaction based on at least one dimension of the transaction matching at least one of the multiple different transaction dimensions identified to the at least one fee in the fee schedule; and
provide the selected at least one fee for the transaction.

10. The non-transitory computer-readable storage media of claim 9, wherein the multiple different transaction dimensions include at least three of: a processing code, a transaction type, a region differentiator, a merchant category code (MCC), and a payment account brand.

11. The non-transitory computer-readable storage media of claim 10, wherein the executable instructions, when executed by the at least one processor, further cause the at least one processor to identify a value for each of the multiple dimensions from the authorization message, prior to selecting the at least one fee.

12. The non-transitory computer-readable storage media of claim 11, wherein the multiple dimensions include a region differentiator; and
wherein the executable instructions, when executed by the at least one processor, further cause the at least one processor to identify a location indicator associated with a location in the authorization message and to search in a region differentiator data structure in the memory for the location, in order to identify the value of the region differentiator.

13. The non-transitory computer-readable storage media of claim 11, wherein the multiple dimensions include a payment account brand; and
wherein the executable instructions, when executed by the at least one processor, cause the at least one processor to identify a primary account number (PAN) in the authorization message and to identify the value of the payment account brand based on a range associated with the PAN.

14. The non-transitory computer-readable storage media of claim 9, wherein each of the multiple fees in the fee schedule includes one of a fixed fee and a percentage fee.

15. The non-transitory computer-readable storage media of claim 9, wherein the executable instructions, when executed by the at least one processor, further cause the at least one processor to:
solicit a fee from the issuer;
receive the solicited fee from the issuer; and
store the received fee as one of the multiple fees in the fee schedule in the memory associated with the at least one processor.

16. A system for use in assessing fees in connection with payment account transactions, the system comprising:
a memory including multiple fee schedules, each of the fee schedules associated with a different issuer, each of the fee schedules including multiple fees, and each of the fees designated for a cross-border transaction and/or a currency exchange transaction and identified to at least one transaction dimension; and
at least one processor in communication with the memory, the at least one processor configured to:
intercept an authorization request for a transaction to a payment account issued by an issuer;
retrieve, from the memory, a fee schedule associated with the issuer;
select at least one fee in the fee schedule associated with the issuer when at least one dimension of the intercepted transaction matches at least one transaction dimension identified to the fee in the fee schedule; and
alter the authorization message to include the selected at least one fee, whereby the at least one fee is assessed to a consumer associated with the payment account.

17. The system of claim 16, wherein the at least one processor is further configured to intercept the authorization request only when the transaction is at least one of a cross-border transaction and/or a currency exchange transaction.

18. The system of claim 17, wherein the at least one dimension for the transaction includes multiple dimensions for the transaction; and
wherein the selected at least one fee includes each fee included in the fee schedule for which the multiple dimensions of the transaction are identified to the fee.

19. The system of claim 18, wherein the at least one processor is further configured to include the selected at least one fee in a clearing record associated with the issuer and/or an acquirer involved in the transaction.

20. The system of claim 19, wherein the at least one transaction dimension includes at least two of: a processing code, a transaction type, a region differentiator, and a merchant category code (MCC).
